(19) United States
(12) Patent Application Publication
(10) Pub. No.: US 2009/0077858 A1
(43) Pub. Date: Mar. 26, 2009

(54) Bobber and sinker for fishing

(75) Inventors: O. Theodore Wright, Overland Park, KS (US); Robert E. Hodgdon, Shawnee, KS (US); Lance G. Rake, Lawrence, KS (US)

Correspondence Address: STEPHEN R. ROBINSON, 1121 PENNSYLVANIA, LAWRENCE, KS, 66044, US

(73) Assignee: Hodgdon/Wright Enterprises, L.L.C.

(21) Appl. No.: 11/903,142

(22) Filed: Sep. 20, 2007

(51) Int. Cl. A01K 93/00; A01K 95/00

(52) U.S. Cl. 43/41.2; 43/17.5; 43/44.9; 43/44.91

(57) ABSTRACT

An improved method for overhead casting and retrieving a fishing jig and bait. The fishing caster provides a generally cylindrical, hollow body having a flat, closed top, a wall and an open bottom. The body presents a body axis from top to bottom. Drag upon reeling in is reduced by a plurality of elliptical vents formed in the wall, each vent presenting an elliptical axis substantially in alignment with the body axis, and by a cone within the hollow body, extending downwardly from the top.

The improved fishing caster also includes structure forming a threading hole in the wall and two radially spaced indentations along the bottom of the body. The indentations form a tooth substantially aligned with the body axis, to secure the fishing line to the caster. A fluorescent lighting stick is mounted on top, for night fishing, as well as location of the caster in foliage.

### BACKGROUND OF THE INVENTION

1. Field of the Invention

The present invention relates to an improved bobber and sinker for fishing. More particularly, it is directed to a method of overhead casting and retrieval of a fishing line by utilizing an inventive caster which allows more accurate casting and secure deployment of bait at a desired placement.

2. Description of Related Art

Effective casting and retrieving of a fishing line is fundamental to a satisfactory fishing experience. Even the novice fisherman knows the hazards of overhead casting with. an exposed hook. The hook may be caught in the back of the person casting or a neighbor close by. Avoiding this basic pitfall by employing a sideways cast introduces new problems. For example, the side cast is typically less accurate. Also, since bait is usually on the line, the sideways cast increases the chances that the bait will fall off the line or be deployed in an undesirable place in the water.

Many attempts have been made to address these problems. For example, U.S. Pat. No. 4,060,925, issued to Bias, attempts to address the overhead casting problem by providing a casting compartment within a bobber, so that the bait and hook are not exposed. Bias also provides a series of vents 45 (see FIG. 3) for quicker discharge of air from the casting compartment as the bobber sinks to its final level in the water. The vents 45 also play a role in reducing drag when the line is being reeled in after casting, by allowing water to escape from the casting compartment during such reeling.

However, the Bias attempt leaves much to be desired. For example, attachment of the fishing line to the bobber is cumbersome. The line is threaded through aperture 46 (FIG. 3) and then secured by limit bead 48 and stop bead 49. See column 4, lines 23-35. This requires beads 48 and 49 to be threaded onto the fishing line without showing how such a process can be done conveniently. It is not clear from the text if this solution is at all practical, much less convenient, as a method of securing the line to the bobber. Also, the Bias vents are not optimized for water flow in the direction of the bobber.

What is needed is a method and apparatus which provide for convenient overhead casting and retrieval of a fishing line. The method should also provide for a convenient, secure way to attach the fishing line to a bobber or sinker. Finally the method should provide a secure way to accurately cast and deploy bait at a desired level in a desirable location in the water.

### SUMMARY OF THE INVENTION

The present invention solves the problems of the prior art by providing an improved method for casting and retrieving a fishing line, typically including a bobber or sinker, as well as a fishing jig and bait. Further, the invention provides a novel method of attaching the casting apparatus for a secure and convenient overhead cast. Finally, the invention provides a convenient method of lighting a bobber for night fishing.

The improved fishing caster provides a generally cylindrical, hollow body having a flat, closed top, a wall and an open bottom. The body presents a body axis from top to bottom. A plurality of elliptical vents is formed in the wall, each vent presenting an elliptical axis substantially in alignment with the body axis. The vents, by allowing water within the hollow body to escape, diminish drag when the line is being reeled in. In particularly preferred embodiments, drag is further diminished by a cone within the hollow body, extending downwardly from the top. The cone channels water through the vents more efficiently when reeling in.

The improved fishing caster also includes structure forming a threading hole in the wall and two radially spaced indentations along the bottom of the body. The indentations form a tooth substantially aligned with the body axis, providing a convenient yet secure method of securing the fishing line to the caster. In preferred embodiments a lip is formed at the top of the tooth to further secure the fishing line. This method also allows the bait to be deployed at a desired depth in the water.

Finally, the invention provides a fluorescent lighting stick which is mounted on top, for convenient night fishing, as well as location of the caster in thick foliage or debris.

### BRIEF DESCRIPTION OF THE DRAWINGS

FIG. 1 is a side elevational view an improved bobber according to the invention;

FIG. 2 is a sectional view of the bobber of FIG. 1;

FIG. 3 is a detailed, partial view of FIG. 1, depicting a tooth formed at the bottom of the bobber, according to the invention;

FIG. 4 is a top view of the bobber of FIG. 1;

FIG. 5 is a side sectional view, analogous to the bobber of FIG. 2, of a sinker according to the invention;

FIG. 6 top view of the sinker of FIG. 5;

FIG. 7 is a partial view of a loop of fishing line configured for attachment to the bobber of FIG. 1 or the sinker of FIG. 5;

FIG. 8 is a detailed view loop of the loop of line of FIG. 7 registered with a threading hole on the wall of the bobber;

FIG. 9 depicts the loop of line (partially in phantom) threaded through the threading hole and extending out from the bottom of the cavity of the bobber;

FIG. 10 depicts the loop of line partially pulled onto the outside of the tooth;

FIG. 11a depicts the loop of line secured on a lip at the top of the tooth, according to the invention;

FIG. 11b is a detailed view of the loop secured to the lip;

FIG. 12 is a side view of the bobber with a jig, bait and hook at the bottom of the assembly and a fishing pole at the top, with the bobber secured between;

FIG. 13 is a detailed view of a vent disposed on the wall of the bobber, according to the invention;

FIG. 14 is an electrical block diagram illustrating an alternative caster; and

FIG. 15 shows the loop of fishing line of FIG. 7 twisted once.

### DETAILED DESCRIPTION

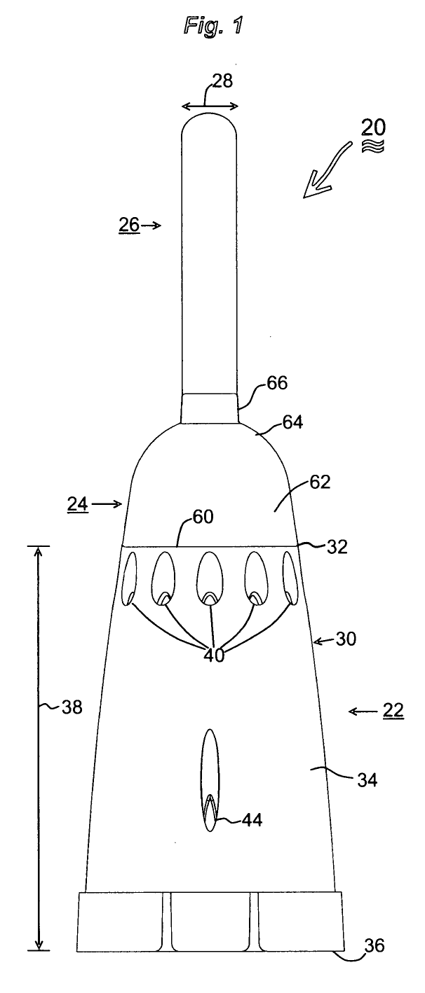

Referring now the figures in general and FIG. 1 in particular, a bobber 20 includes a caster 22, an air compartment 24 and a chemical fluorescent light stick 26. Stick 26 has an approximate length of three inches and a diameter of ⅝ inches as indicated at reference numeral 28. Stick 26 typically has a lighting time of about three to six hours before the lighting function is lost. Stick 26 may then be replaced by a duplicate if desired.

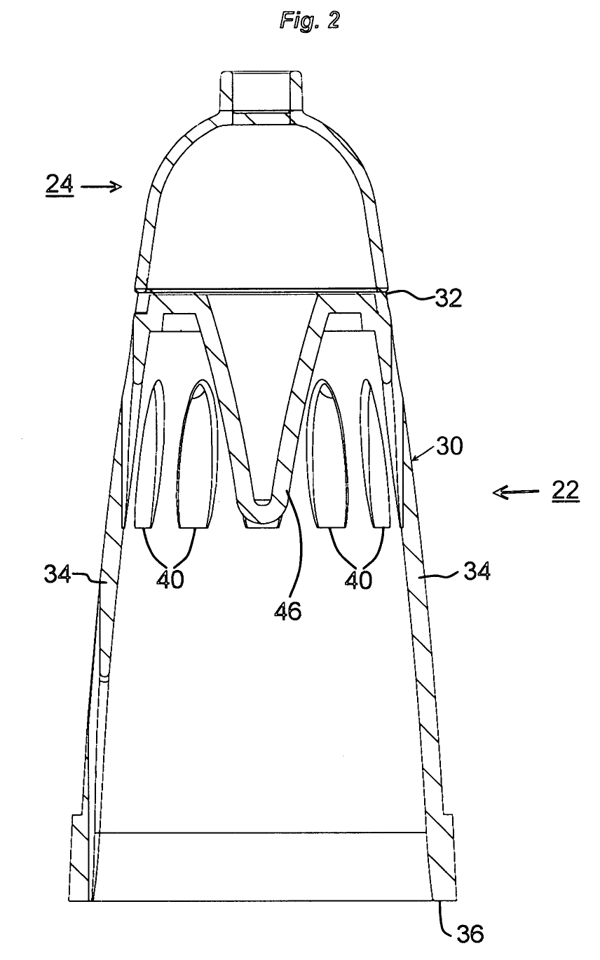

Caster 22 has a generally cylindrical, somewhat conical, hollow body 30 having a flat closed top 32, a wall 34 and an open bottom 36 (see also FIG. 2). Body 30 presents a body axis from top to bottom as illustrated at reference numeral 38. Caster 22 is preferably made of a synthetic resin.

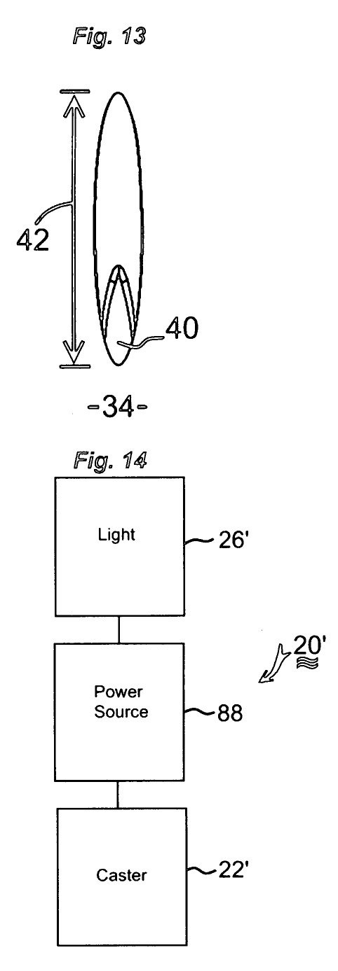

Portions of wall 34 form a plurality of elliptical vents 40, each vent 40 presenting an elliptical axis 42 (see FIG. 13). Elliptical axis 42 is substantially in alignment with body axis 38.

Other structure in wall 40 forms a threading hole 44.

Referring to FIG. 2, bobber 22 is shown sectionally without stick 26. A cone 46 is disposed within caster body 30 extending downwardly from caster top 32.

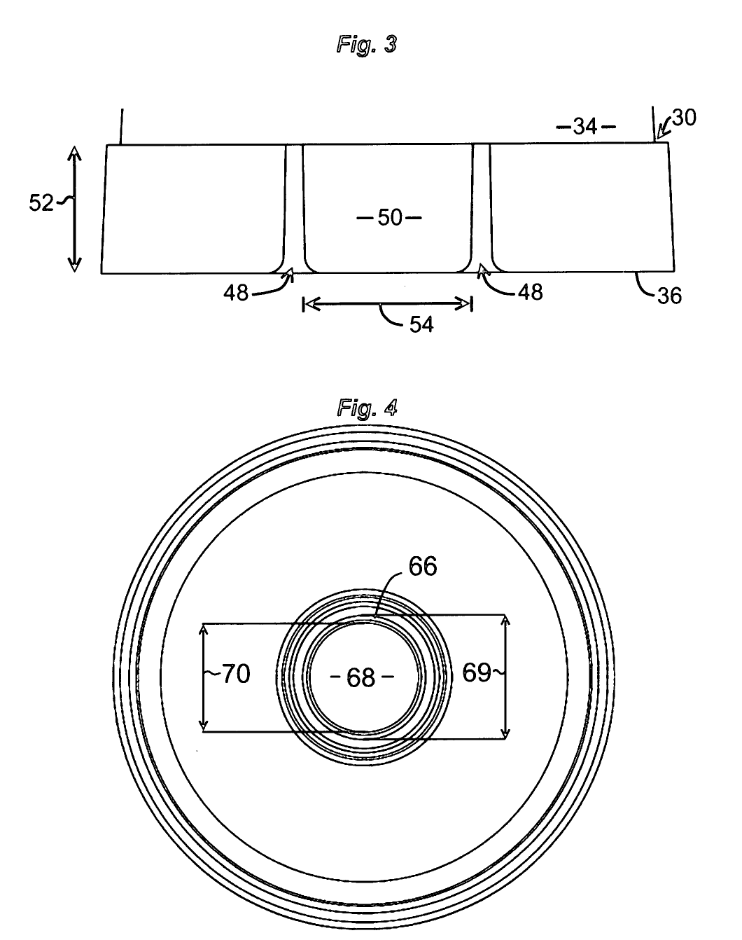

Referring to FIG. 3, structure at bottom 36 of body 30 forms two radially spaced indentations 48. The indentations 48 from a tooth 50 substantially aligned with body axis 38 (see tooth axis as illustrated at reference numeral 52). Indentations 48 have a radial spacing there between of 45 inches in the preferred embodiment. However the radial spacing indicated at reference numeral 54 may vary in a range between 0.1 and 2.0 inches. A length of 60-70 degrees of radial circumference but 30 degrees is about optimal. The length of the body 30 is three inches deep inside cone, is preferred with a diameter 1.3 inches at bottom 36.

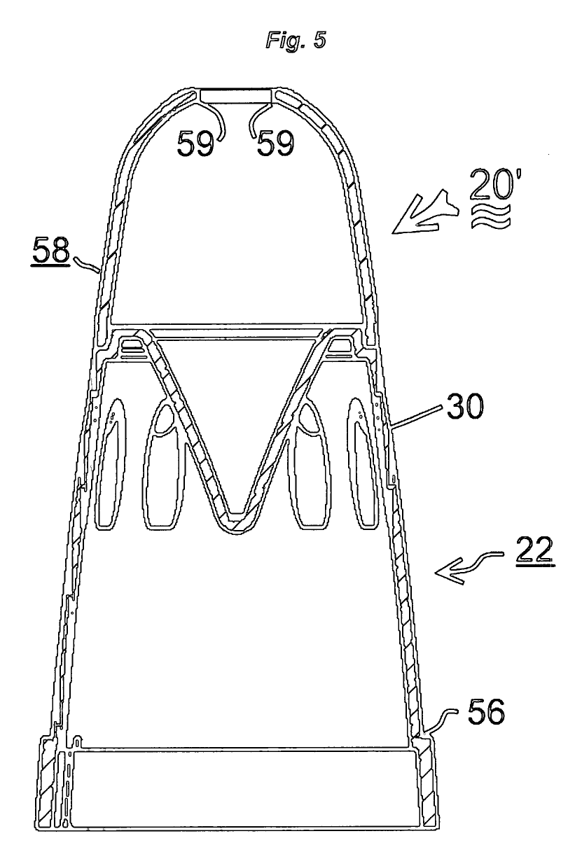

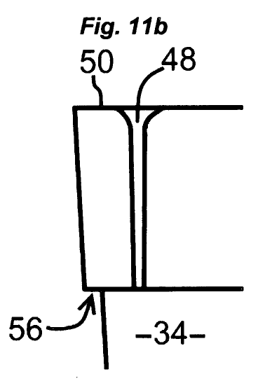

Topmost portions 54 of tooth 50 and other portions of bottom 36 project radially from body 30 to form a recessed lip 56 (see FIGS. 5, 11a and 11b for additional views of lip 56).

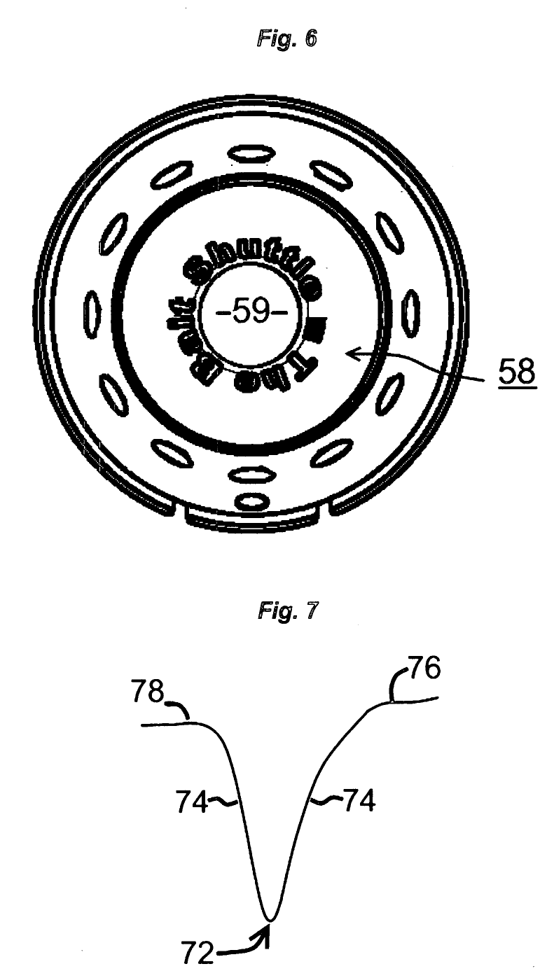

Referring to FIG. 5, a sinker 20′ is shown in cross section (analogous to cross section of FIG. 2). Sinker 20′ is the same as bobber 20 of FIG. 1 (for example caster 22 is identical) except no air compartment 24 is used nor is there is a lighting stick 26. Instead, sinker 20′ has a solid sinker hat 58 formed on the top 32 and portions of sinker hat 58 forming a hole 59 at the top thereof of body 30. (See also FIG. 6 for a top view of sinker hat 58 and hole 59). In preferred embodiments the diameter of the hole is ⅝ inches, but may range from 0.3 inches to 1.5 inches.

Referring again to FIG. 1, air compartment 24 emerges upwardly from top 32 of the body 30 of caster 22. Air compartment 24 is somewhat conical in shape with a bottom 60, a radial wall 62, a top 64 and topmost portions 66. Air compartment 24 is sealed so as to contain air within.

Referring to FIG. 4, in a top view, topmost portions of 66 are shown to form a circular recess 68 therein. Circular recess 68 has a diameter of 0.26 inches (outside) diameter as indicated at reference numeral 69 and 0.23 inch (inside) diameter indicated at reference numeral 70 for easy mechanical attachment and/or detachment of stick 26 (not shown in FIG. 4) matingly received in the circular recess 68. Topmost portions 66 are configured for compression of light stick by wall and lower surface grip.

Referring to FIG. 14, a bobber 20′ is shown in electrical block diagram. Caster 22 is modified structurally to accommodate mechanically and electrically power source 88 which in turn is connected to 26′. Light source 26′ may be a light bulb or the like and power source 88 is preferably some sort of battery.

Turning now to the operation of the invention, first a discussion of the assembly of elements for casting will be rehearsed and then secondly the actual use of the invention in fishing.

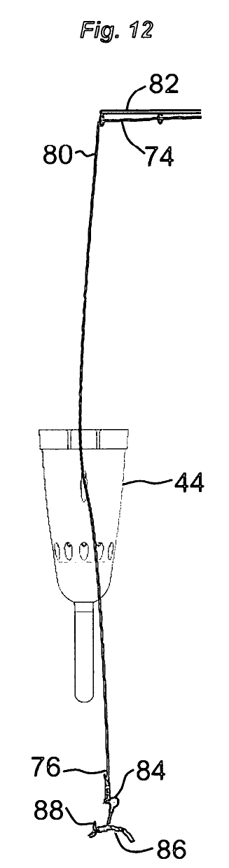

Referring to FIG. 7, the first step in assembly of elements for casting (note that the procedure is exactly the same for bobber 20 or sinker 20′) is the creation of a loop 72 of fishing line 74. Loop 72 presents a first side 76 and a second side 78. First side 76 of loop 72 is connected to a fishing hook 80 (shown in FIG. 12) and the second side 78 of loop 72 is connected to a fishing pole 82 (shown in FIG. 12).

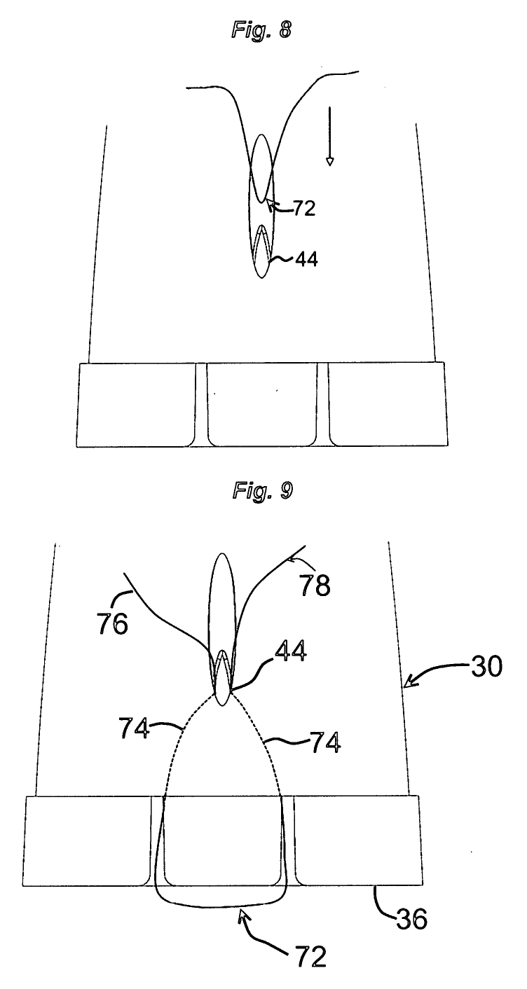

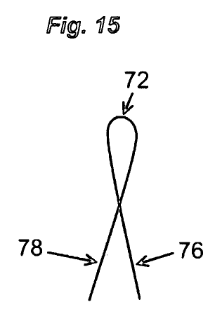

Referring to FIG. 8, loop 72 is registered with threading hole 44. Next, loop 72 is threaded through hole 44 and into the interior of caster body 30 by moving loop 72 in the direction indicated by the arrow in FIG. 8. When loop 72 has been moved sufficiently through threading hole 44 it will emerge from the bottom 36 of caster body 30 as indicated at FIG. 9. Note that portions of fishing line 74 are depicted in phantom because they are in the interior of body 30. At this time, it may be beneficial to put a twist in loop 72 as shown at FIG. 15.

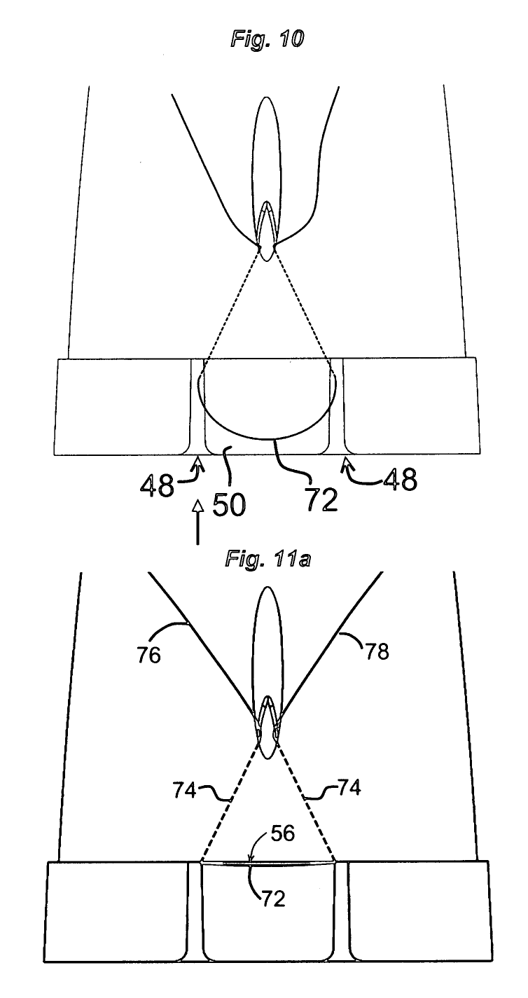

Referring to FIG. 10, loop 72 is now pulled back in the direction indicated by the arrow in FIG. 10 but positioned so that loop 72 comes on the outside of tooth 50. Loop 72 is continued to be pulled upwardly as indicated by the arrow in FIG. 10 until the position is reached as illustrated in FIG. 11a. When loop 72 has been completely pulled across tooth 50, it reaches recessed lip 56 (see FIG. 11b for more detail). In this fashion, loop 72 is snugly held in recessed lip 56, especially with the twist illustrated in FIG. 15.

After this process of engaging loop 72 with lip 56 has been completed, a jig 84, a piece of bait 86 and hook 80 are allowed to dangle below threading hole 44 on end 76 of fishing line 74, while bobber 20 is suspended upside down from pole 82 by means of second side 78 of line 74, as shown in FIG. 12. Thus the assembly of fishing rod 82, line 74, bobber 20, jig 84, bait 86 and hook 80 is held securely by gravitation through threading hole 44 and mechanical forces at recessed lip 56, as shown. Now caster 22 of bobber 20 is ready to be loaded.

All components of first end 76 of fishing line 74 (namely jig 84, bait 86 and hook 80) are now manually put inside of body 30 of caster 22 as shown at FIG. 13. The assembly is now ready for casting.

Fishing operation will now be discussed. A fisherman (not shown) may now grasp pole 82 and make an overhead cast in the conventional manner (i.e. with jig 84, bait 86, hook 80 and most of line 74 located on first side 76 are contained in the interior of caster 22). Because hook 80 is enclosed in caster body 30 there is no chance of the person casting (or anyone close by) getting hooked. The cast can be made accurately because it is overhand and because essentially all load weight is contained in caster body 30. When bobber 20 hits the water (not shown) it moves to an upright position, such as shown in FIG. 1. Now jig 84, bait 86 and hook 80 gravitationally sink down to the appropriate level, i.e. the predetermined length of first end 76 chosen by the fisherman to extend from threaded hole 44. Vents 40 aid caster body 30 in dispelling air from the interior thereof. Once the jig 84, bait 86 and hook 88, have reached the appropriate level below the water surface, the fisherman may then leave the bobber 20 in place in the water for as long as desired. Whenever another cast is desired, bobber 20 is easy to locate because of bobber coloring and the lighting of stick 26, especially in thick foliage or at night.

Whenever reeling in line 74, the load on line 74 is reduced (i.e. easier to reel) because of elliptical vents 40 aligned with the direction of water flow through the interior of caster body 30, which is the same as the axis indicated by reference numeral 42 in FIG. 13. Escape of water while reeling in, is further enhanced by cone 46 which routes water to vents 40 as reeling occurs.

The differences between the previously discussed operation and that when sinker 20′ is utilized, will now be discussed. On casting, when sinker hat 58 strikes the water, hole 59 allows some water to fill in to the cavity of sinker hat 58. Then sinker 20′ flips so that it is in the orientation shown in FIG. 5. At that point, sinker 20′ sinks more rapidly due to the weight of water already partially filling the cavity in sinker hat 58. The relationship of the diameter of hole 59 to the shape of sinker hat 58 and volume of the sinker hat cavity should be optimized for the action described immediately above. Also, upon reeling in sinker 20′, the cavity is drained of water upon extraction from the surface of the water and therefore sinker 20′ is immediately ready for another cast, except for re-loading of bait 86, etc., into the caster body 22.

It should be apparent that the invention not only accomplishes the major functions required from such systems but does so in a particularly advantageous manner. It should be equally apparent, however, that various minor and equivalent modifications from the embodiments disclosed herein for illustrative purposes could be employed without departing from the essence of the invention. It is to be understood, therefore, that the invention should be regarded as encompassing not only the subject matter literally defmed by the claims which follow, but also technical equivalents thereof.

What is claimed is:

1. A fishing caster comprising:
(a) a generally cylindrical, hollow body having a flat, closed top, a wall and an open bottom, the body presenting a body axis from top to bottom; and
(b) structure forming a plurality of elliptical vents in the wall, each vent presenting an elliptical axis substantially in alignment with the body axis.

2. The fishing caster of claim 1 further including a cone within the hollow body, extending downwardly from the top.

3. The fishing caster of claim 1 further including an enclosed air compartment emerging upwardly from the top of the body.

4. The fishing caster of claim 1 further including a solid sinker hat formed on top of the body.

5. The fishing caster of claim 1 further including:
(a) structure forming a threading hole in the wall; and
(b) structure forming two radially spaced indentations along the bottom of the body, the indentations forming a tooth substantially aligned with the body axis.

6. The fishing caster of claim 5 further including topmost portions of the tooth projecting radially from the body to form a recessed lip.

7. The fishing caster of claim 3, the air compartment including topmost portions forming a circular recess and a fluorescent lighting stick matingly received in the circular recess.

8. A fishing caster comprising:
(a) a generally cylindrical, hollow body having a flat, closed top, a wall and an open bottom, the body presenting a body axis from top to bottom;
(b) structure forming a threading hole in the wall; and
(c) structure forming two radially spaced indentations along the bottom of the body, the indentations formiing a tooth substantially aligned with the body axis.

9. The fishing caster of claim 8 wherein the indentations have a radial spacing ranging from 0.1 inches to 2.0 inches.

10. The fishing caster of claim 8 futrther including topmost portions of the tooth projecting radially from the body to form a recessed lip.

11. The fishing caster of claim 8 further including an enclosed air compartment emerging upwardly from the top of the body.

12. The fishing caster of claim 8 fuirther including a solid sinker hat formed on top of the body.

13. The fishing caster of claim 8 flirther including structure forming a plurality of elliptical vents in the wall, each vent presenting an elliptical axis substantially in alignment with the body axis.

14. The fishing caster of claim 13 further including a cone within the hollow body, extending downwardly from the top.

15. The fishing caster of claim 11, the air compartment including topmost portions forming a circular recess and a fluorescent lighting stick matingly received in the circular recess.

16. A fishing bobber comprising:
(a) a generally cylindrical, hollow body having a flat, closed top, a wall and an open bottom, the body presenting a body axis from top to bottom;
(b) an enclosed air compartment emerging upwardly from the top of the body, the compartment including topmost portions forming a circular recess; and
(c) a fluorescent lighting stick matingly received in the circular recess.

17. The fishing bobber of claim 16 further including structure forming a plurality of elliptical vents in the wall, each vent presenting an elliptical axis substantially in alignment with the body axis.

18. The fishing bobber of claim 17 further including a cone within the hollow body, extending downwardly from the top.

19. The fishing bobber of claim 16 further including:
(a) structure forming a threading hole in the wall; and
(b) structure forming two radially spaced indentations along the bottom of the body, the indentations forming a tooth substantially aligned with the body axis.

20. The fishing bobber of claim 19 fuirther including topmost portions of the tooth projecting radially from the body to form a recessed lip.

21. A fishing sinker comprising:
(a) a generally cylindrical, hollow body having a flat, closed top, a wall and an open bottom, the body presenting a body axis from top to bottom; and
(b) a sinker hat emerging upwardly from the body, the hat including topmost portions forming a hole, the hat also partially enclosing a cavity therein, with the hole in fluid communication with the cavity.
